(19) United States
(12) Patent Application Publication
(10) Pub. No.: US 2014/0217695 A1
(43) Pub. Date: Aug. 7, 2014

(54) Crank Assembly

(71) Applicant: Sergio Landau, Laguna Niguel, CA (US)

(72) Inventor: Sergio Landau, Laguna Niguel, CA (US)

(21) Appl. No.: 13/792,191

(22) Filed: Mar. 11, 2013

Related U.S. Application Data
(60) Provisional application No. 61/761,216, filed on Feb. 5, 2013.

(51) Int. Cl. B62M 3/04

(52) U.S. Cl. CPC B62M 3/04
USPC 280/261; 74/594.1

(57) ABSTRACT

This invention provides a novel solution for an optimally powered crank for a human-powered vehicle, such as a bicycle. This invention includes a novel system and method to optimize the length of each crank arm throughout the revolution of the crank assembly. First, a crank arm assembly is attached to the bicycle's existing spindle assembly. The crank arm assembly includes a rail section that is fixed at one end to the mounting section of the crank arm assembly. Next, the opposite end of the rail section is attached to the sliding section of the crank arm assembly. The sliding section of the crank arm assembly also includes a feature that allows the sliding section to collapse and expand along the rail section. The crank arm assembly also includes at least two track rollers mounted to the side of each sliding section designed to reduce friction and counter inertial forces associated with the crank arm assembly sliding along the tracks. Next, the assembly includes two tracks mounted on each side of the frame. The tracks are used to control the length of the crank arms at each angular position. Finally, the shape of each track is designed to coincide with the optimum crank arm length at the various angular positions as the crank arm rotates through a complete revolution.

### CROSS-REFERENCE TO RELATED APPLICATIONS

The present application is related to and claims priority from prior provisional application Ser. No. 61/761,216 filed Feb. 5, 2013 the contents of which are incorporated herein by reference.

### FIELD OF THE INVENTION

This invention is in the field of human powered machines, and in particular a crank assembly, such as a crank assembly for bicycles.

### BACKGROUND OF THE INVENTION

Human-powered machines, such as bicycles, have played important roles in human lives since the invention of the wheel. Various forms of human-powered cycles, such as bicycles, tricycles, and scooters are used every day for recreation and work in just about every society throughout the world. Even a small enhancement that results in weight reduction, size reduction, cost reduction, increased energy conversion, increased speed, or ease of use will have a drastic impact.

The basic design of a bicycle consists of a frame, a pair of wheels, a steering mechanism, and a crank assembly. The traditional crank system consists of crank with pedals coupled by a chain to a rear gear that is attached to the rear wheel. The rider rotates the cranks system to propel the bicycle forward. The traditional crank system includes two diametrically opposed crank arms with fixed lengths. However, the crank system with fixed-length crank arms is not optimally efficient.

Bicycles are generally efficient, comfortable, and fast on flat or downhill surfaces. However, for uphill, rough terrain, mountain bike riding, or whenever there is a gain in elevation, bicycles with fixed-length crank arms become inefficient. The same issue also exists in other types of crank driven machines. It becomes necessary to downshift the gears, and apply greater force onto the pedals to increase torque. The downshifting and the increased effort demanded cause a loss in momentum, making the bike move slower and therefore less efficiently.

This invention provides a novel solution for an optimally powered crank system for a vehicle, or machine. This invention enables a crank system that is more efficient than a traditional crank system. This invention includes a system and methods to provide more torque in the down-stroke without requiring the application of more force. This invention includes a novel system and method to optimize the length of each crank arm throughout the revolution of the crank assembly.

### BRIEF SUMMARY OF THE INVENTION

One embodiment of the invention is a crank assembly designed to allow the length of the crank arms to vary throughout the revolution of the crank. The invention is designed such that it can be used with existing vehicles, or machines. One example of such a vehicle, or machine, is a bicycle, however the invention may also be used with other crank driven machines. First, a crank arm assembly is attached to the bicycle's existing spindle assembly. The crank arm assembly comprises a mounting section, rail section, and sliding section. The crank arm assembly includes a rail section that is fixed at one end to the mounting section of the crank arm assembly. The rail section comprises a predominately solid piece of material with smooth bearing surfaces. Next, the opposite end of the rail section is attached to the sliding section of the crank arm assembly. The sliding section of the crank arm assembly also includes features that allow the sliding section to collapse and expand along the rail section. The sliding section may also include friction-reducing features. The crank arm assembly also includes at least two track rollers mounted to the side of each sliding section. The track rollers are designed to reduce friction and counter inertial forces associated with the crank arm assembly sliding along the tracks. Next, the assembly includes two tracks mounted on each side of the bike frame. The tracks are mounted to the bike frame with mounting brackets. The tracks are used to control the length of the crank arms at each angular position. The shape of each track is designed to coincide with the optimum crank arm length at the various angular positions as the crank arm rotates through a complete revolution. Finally, the trajectory of the pedals in this invention follows a unique curve designed to allow the optimum expansion and contraction of the crank arms without sacrificing the spinning momentum.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a figure illustrating the various pedal efficiency zones of a typical crank assembly;

FIG. 2 is a figure illustrating the power and recovery zones for the crank assembly in accordance with the teachings of the present invention;

FIG. 3 is a figure of an exemplary embodiment illustrating the crank assembly designed to allow the length of the crank arms to vary throughout the revolution of the crank assembly used in a regular bike frame in accordance with the teachings of the present invention;

FIG. 4 is a figure of an exemplary embodiment illustrating a crank arm assembly in accordance with the teachings of the present invention;

FIG. 5 is a figure of an exemplary embodiment illustrating a bike frame with the crank arm assembly in accordance with the teachings of the present invention;

FIG. 6 is a figure of an exemplary embodiment illustrating the mounting section and rail section components of the crank arm assembly in accordance with the teachings of the present invention;

FIG. 7 is a figure of an exemplary embodiment illustrating the mounting section, rail section, and sliding section of a fully extended crank arm assembly in accordance with the teachings of the present invention;

FIG. 8 is a figure of an exemplary embodiment illustrating the crank arm assembly with a single rail section in accordance with the teachings of the present invention;

FIG. 9 is a figure of an exemplary embodiment illustrating the crank arm assembly with track rollers interfacing with a track in accordance with the teachings of the present invention;

FIG. 10 is a diagram of an exemplary embodiment illustrating the mounting bracket and track attached to a bike frame in accordance with the teachings of the present invention;

FIG. 11 is a diagram of an exemplary embodiment illustrating the bicycle with the crank assembly and the unique curve the optimized crank arm assembly follows in accordance with the teachings of the present invention;

FIG. 12 is a diagram of an exemplary embodiment illustrating the crank arm's varying length as the crank assembly revolves about the spindle in accordance with the teachings of the present invention;

FIG. 13 is a figure illustrating the friction reducing techniques in accordance with the teachings of the present invention; and

FIG. 14 is an illustration showing the preferred embodiment for the track geometry in accordance with the teachings of the present invention.

### DETAILED DESCRIPTION OF THE INVENTION

The following describes the details of the invention. Although the following description will proceed with reference being made to illustrative embodiments, many alternatives, modifications, and variations thereof will be apparent to those skilled in the art. Accordingly, it is intended that the claimed subject matter be viewed broadly. Examples are provided as reference and should not be construed as limiting. The term “such as” when used should be interpreted as “such as, but not limited to.”

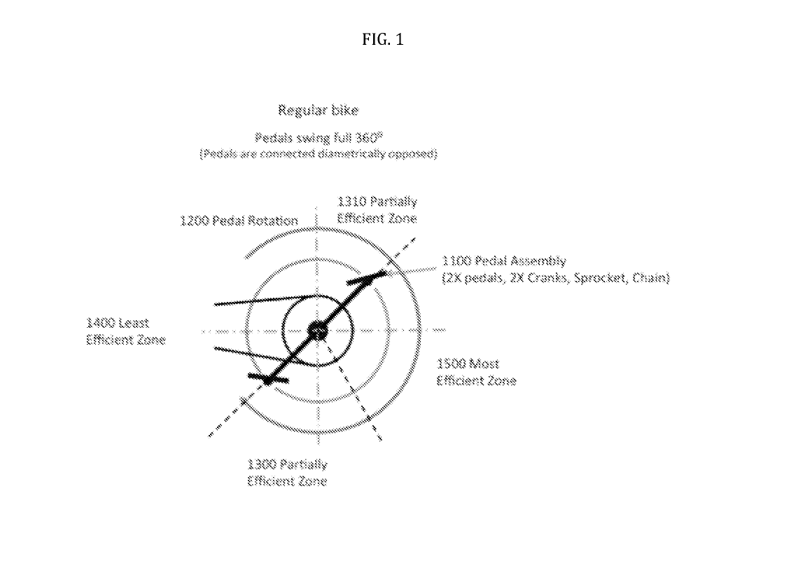

FIG. 1 illustrates the efficiency of a pedal swing of a regular crank assembly 1100 with fixed-length crank arms. A regular bike includes a pedal swing that encompasses three hundred and sixty degrees with a diametrically opposed pedal assembly 1100. Approximately one hundred and five degrees of a pedal swing is only partially efficient, as represented by the partially efficient zones (1310 and 1300). In these partially efficient zones approximately 30% of the total torque generated by a full pedal swing is generated. The least efficient zone 1400, also referred to as the recovery zone, generates nearly zero torque. The remaining portion of the pedal swing is the most efficient zone 1500. Approximately 70% of the total torque generated by a full pedal swing is generated in the most efficient zone 1500.

The amount of torque generated by a pedal swing can be calculated by multiplying the force applied by the rider and the length of the crank arm. Thus the only way to increase the torque with a fixed-length crank arm assembly is to increase the amount of force applied by the rider, since the crank arm length is constant along the 360 degree revolution.

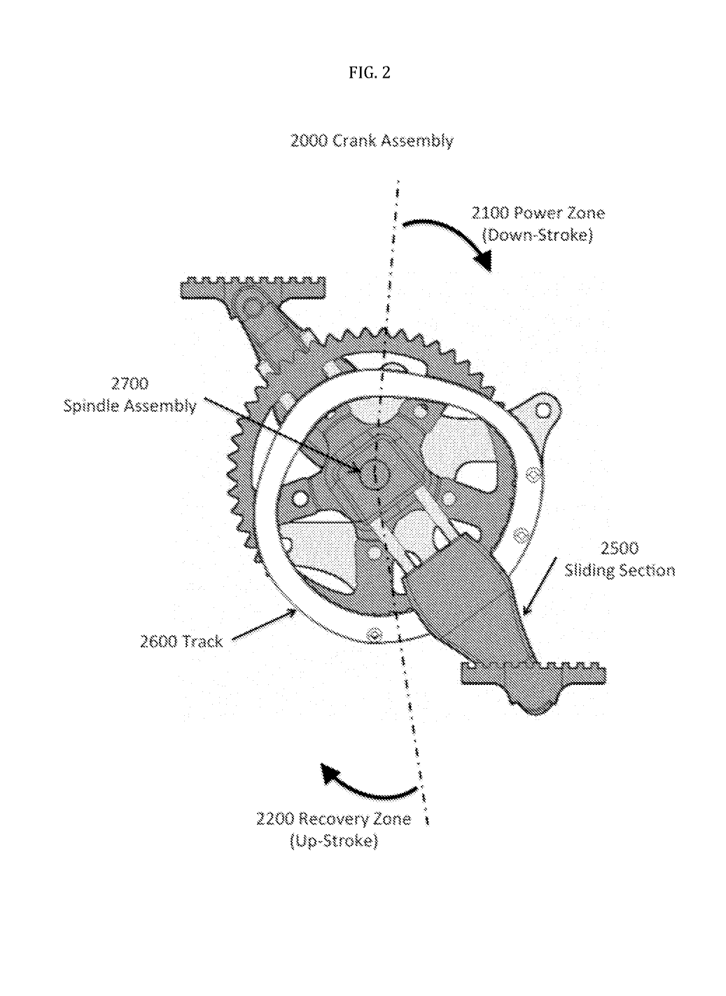

FIG. 2 illustrates a novel crank assembly 2000 and method to provide more torque in the power zone 2100, also referred as the down-stroke, of each pedal revolution by optimizing the length of each crank arm throughout the revolution of the crank assembly 2000. The sliding section 2500 immediately starts to extend as the crank arm swings into the power zone 2100. The sliding section 2500 extends to the fully extended position to maximize the amount of torque applied as the crank arm swings through the power zone 2100. The sliding section 2500 begins collapsing as the crank arm assembly swings through the recovery zone 2200, also referred as the up-stroke. The cycle is continuously repeated for each diametrically opposed crank arm as long as cranking force is applied. It is critical that the sliding section does not begin collapsing until the down-stroke cranking force applied is diminished, for example the down-stroke pedaling force applied by a bicycle rider passes beyond the power zone 2100 and into the recovery zone 2200. Otherwise the sliding motion of the sliding section will have to overcome the opposing down-stroke force. This results in a loss of momentum that will disrupt the rotation of the crank assembly.

Weight-to-strength ratio is an important design consideration for several potential uses of this invention, such a bicycle design. As such, each of the components referenced in this invention are designed in a manner to optimize the strength-to-weight ratio to minimize the amount of weight added to the assembly. For example, the components may be made using a hollow geometries, such as a hollow shaft, and/or be made of materials with optimum strength-to-weight ratios such as aluminum, chrome alloys, steel alloys, titanium, carbon fiber, and the like.

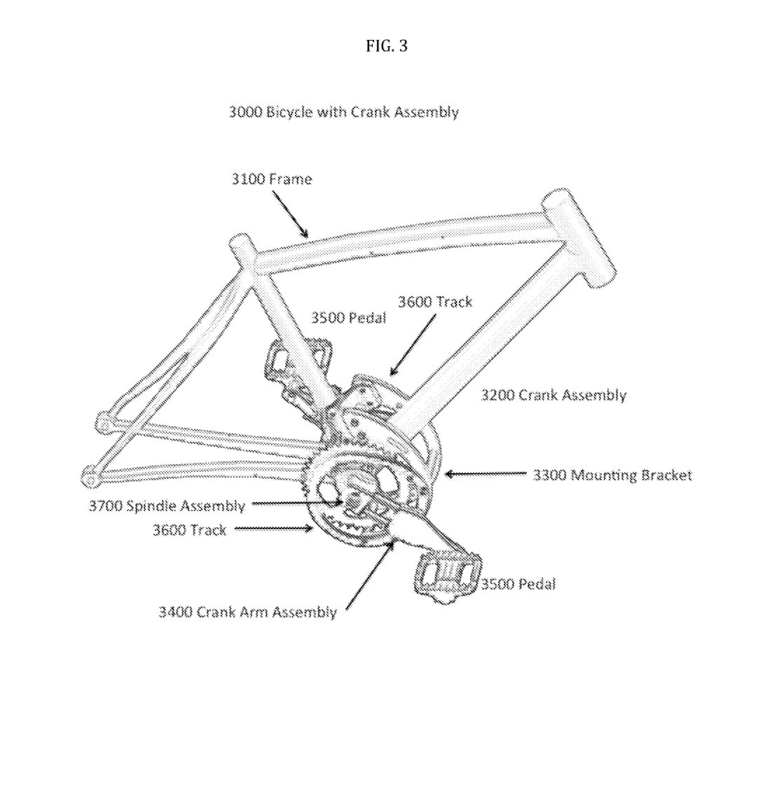

FIG. 3 illustrates a bicycle with the crank assembly 3000 designed to allow the length of the crank arms 3400 to vary as the crank arms 3400 rotate about the spindle 3700. The invention is designed such that it can be used with existing bicycles. For example, the invention may be mounted to any bicycle frame 3100 and spindle assembly 3700. This invention could be provided as an accessory to existing bikes, as the crank assembly can be mated to of an existing bicycle frame, without interfering with the existing wheels, sprockets, brakes, shifters, or any other components. The invention is described as used with a three-piece crank assembly including a main spindle, and two crank arm assemblies. However, one skilled in the art will recognize that the invention may also be used with a single-piece crank assembly.

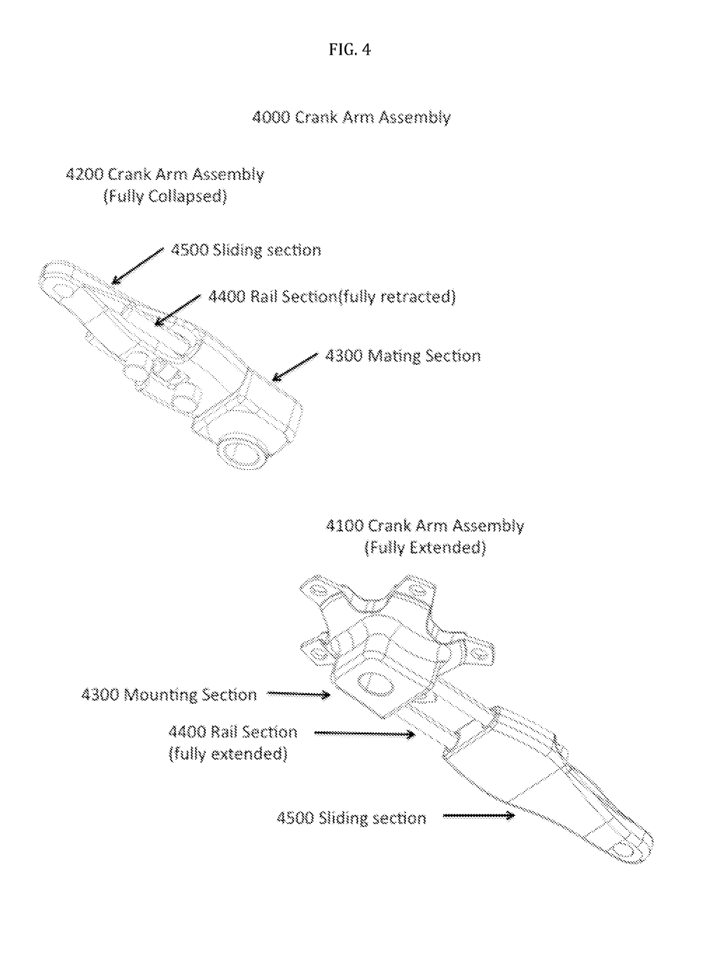

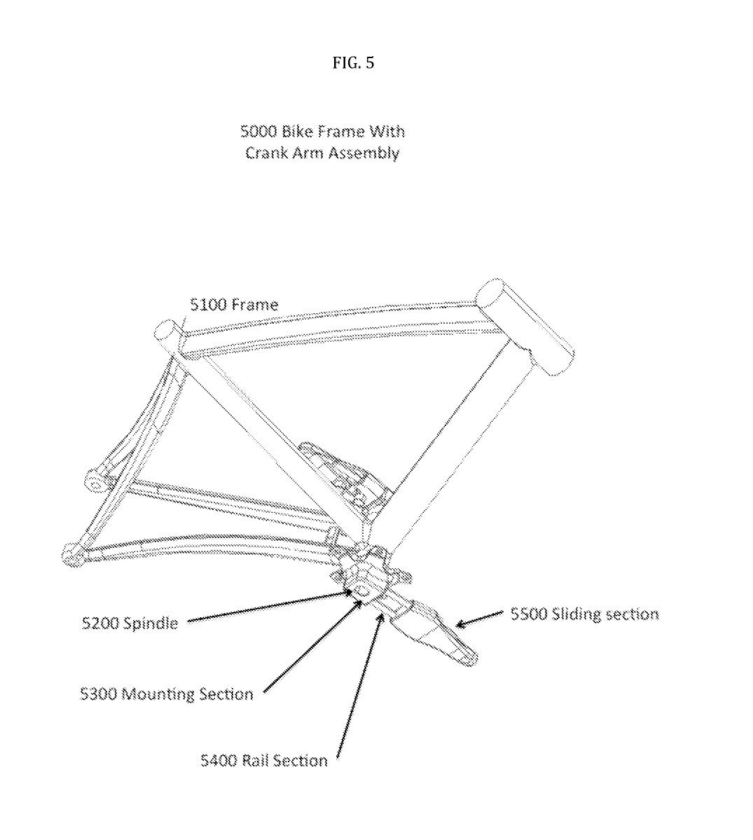

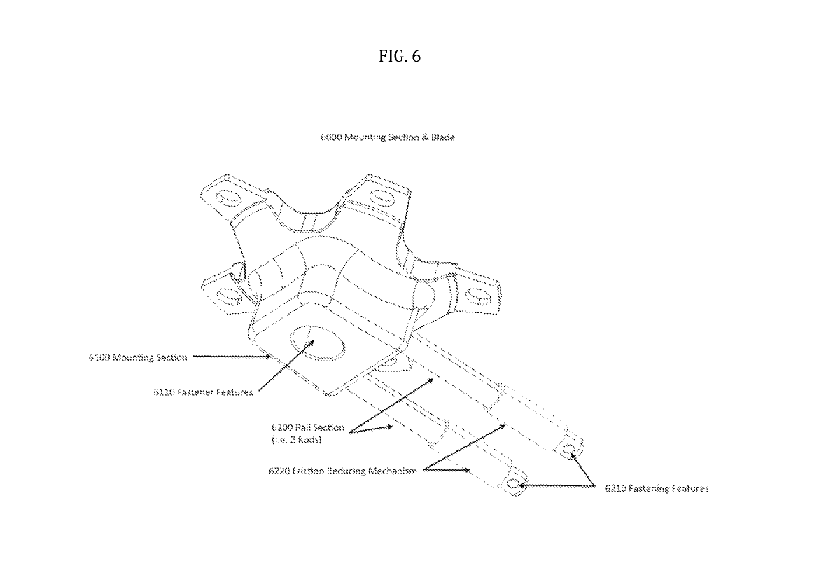

First, a crank arm assembly 3200 is attached to the bicycle's existing main spindle assembly 3700. FIG. 4 illustrates the crank arm assembly 4000, which comprises a mating section 4300, rail section 4400, and sliding section 4500. The mounting section 4300 is designed to attach to the main spindle assembly 5200, referring to FIG. 5. FIG. 6 shows the mounting section 6100 including fastener features 6110 used to mate with the main spindle assembly 5200. The fastener features 6110 may include treads to mate with threaded protruding studs, or it may be unthreaded with the mounting section 6100 attached with fasteners such as a threaded nuts.

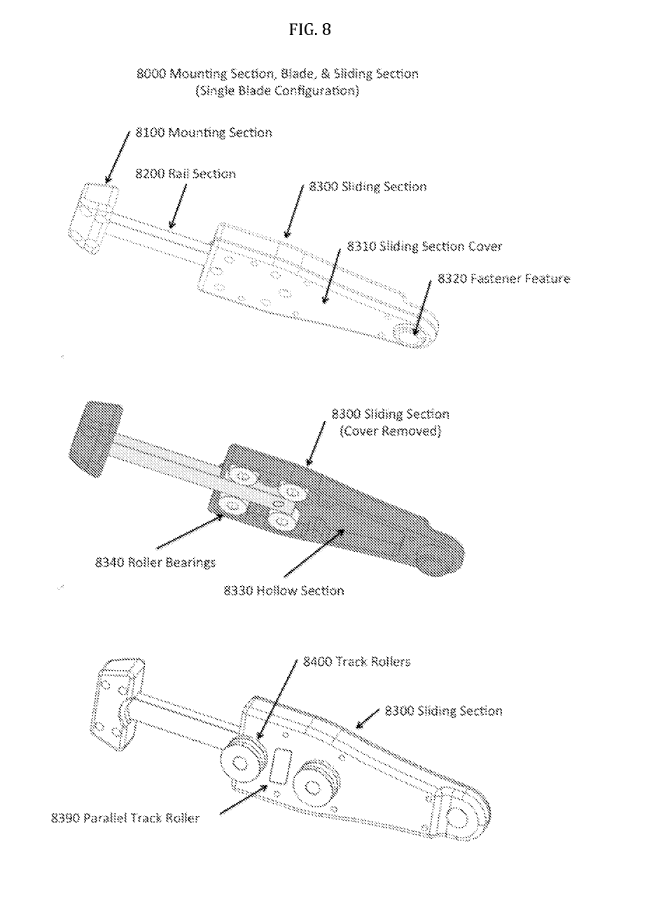

Next the crank arm assembly includes a rail section 6200 that is fixed at one end to the mounting section 6100 of the crank arm assembly. In the preferred embodiment, the rail section consists of two cylindrical rods. FIG. 8 illustrates an alternate configuration where the rail section 8200 is made from a single piece of material. The rail sections 6200 comprise predominately solid pieces of material with at least two smooth bearing surfaces 8220, referring to FIG. 8. To optimize the weight the geometry of the rail sections 6200 may include through holes, or gussets to optimize the strength to weight ratio needed for associated loads and stresses. The cross sectional geometry of the rail sections 6200 may also be formed with different geometries. For example, the cross sectional geometry may be rectangular, square, round, or oval. In addition, the rail sections 6200 may be permanently fixed to the mounting section 6100. In fact, the rail sections 6200 and mounting section 6100 may be fabricated from a single process such as being machined from a single block of material, or formed as a single piece from a mold. Alternatively, the rail sections 6200 may be replaceable. For example, the rail sections 6200 may be mounted to the mounting section with fastening features. In this configuration, the rail sections 6200 may be exchanged with a different length rail section to allow the overall crank assembly to change. Also the tracks 3600 (referring to FIG. 3) would be replaced with a different sized track to accommodate the different crank assembly. This may be beneficial for riding in different terrains or with different riders, such as the optimum crank lengths for a child may be different for an adult.

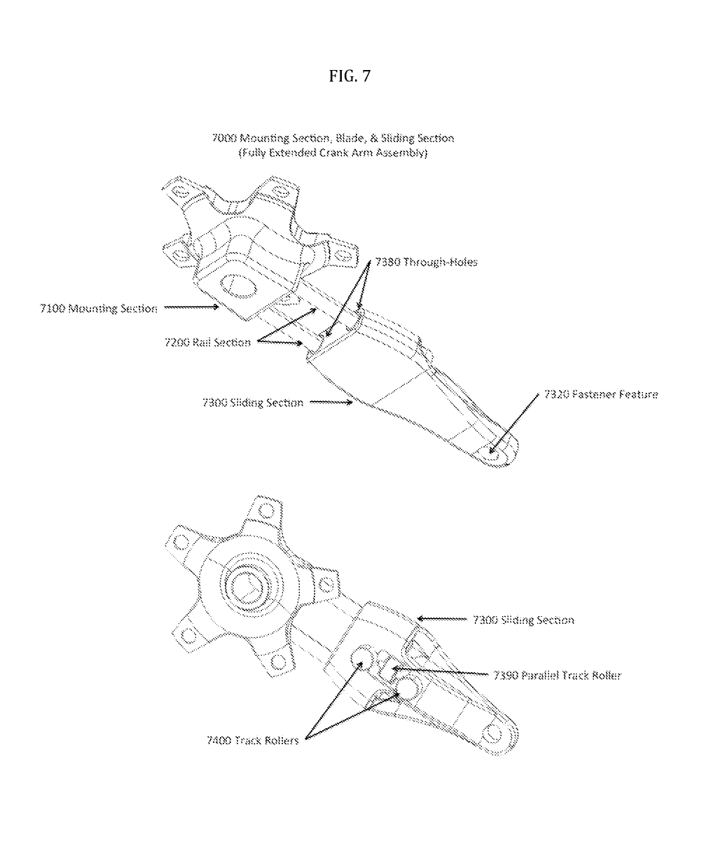

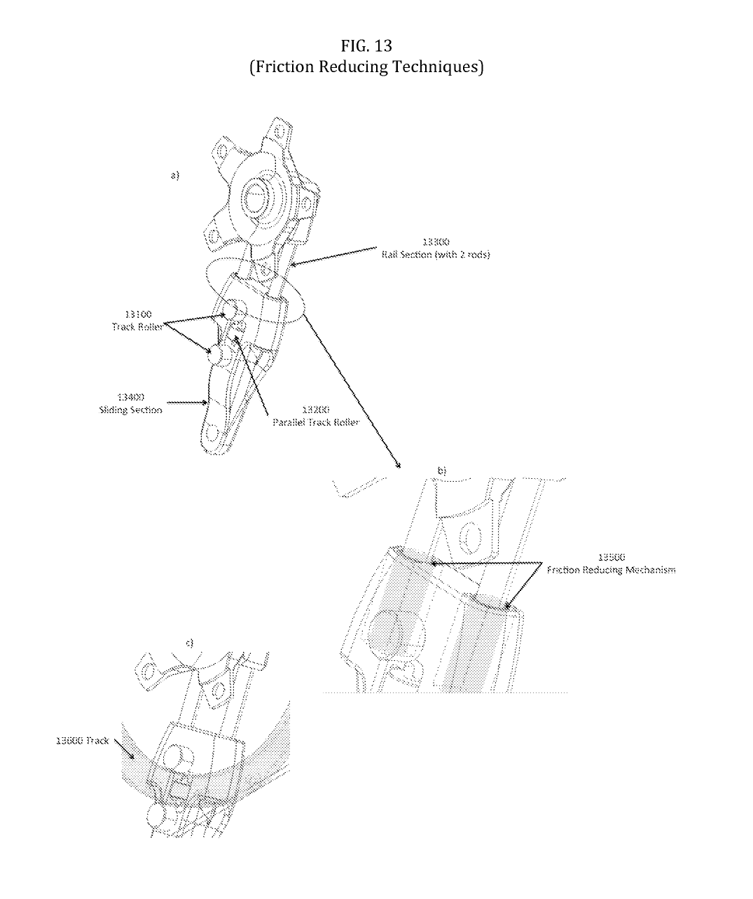

Next, FIG. 7 shows the opposite end of the rail section 7200 interfaced to the sliding section 7300 of the crank arm assembly 7000. The opposite end of the rail sections 7200 may also include a feature that prevents the sliding section 7300 from becoming disconnected to the crank arm assembly. For example, the opposite end of the rail sections 7200 may include a protrusion that prevents it from disconnecting from the rail sections 7200. Or as shown in FIG. 6, the opposite end of the rail sections 6200 may include a fastening feature 6210 used to mate with a fastening feature on the sliding section, 7300 in FIG. 7. The sliding section 7300 of the crank arm assembly also includes features that allow the sliding section 7300 to collapse and expand along the rail sections 7200. For example, the sliding section 7300 may include through holes 7380 designed such that each rail section 7200 can expand and collapse, thus increasing and decreasing the overall crank arm length. As shown in greater detail in FIG. 13, the sliding sections 13400 include friction-reducing mechanisms 13500, such as low friction bushings, to reduce frictional forces as the sliding section 13400 expands and collapses along the rail sections 13300. The friction-reducing features 13500 may be press fit, glued, soldered, brazed, or otherwise fixed to the surface of the through holes in the sliding section 13400.

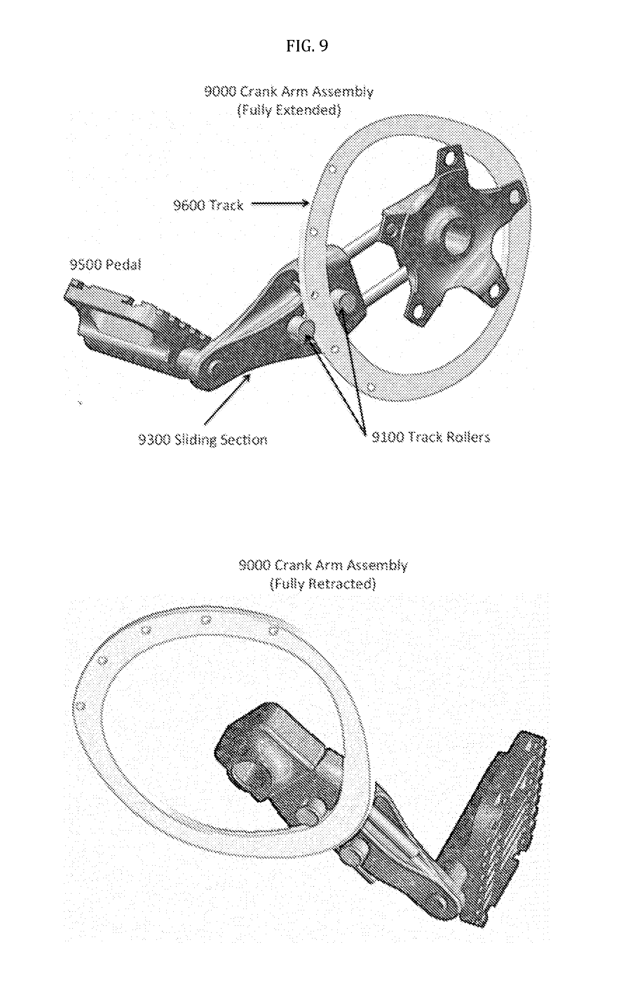

Referring to FIG. 7, the sliding section 7300 also includes track rollers 7400 mounted on the side of the sliding section that interfaces with the tracks. The track rollers 7400 are designed to run freely along the bearing surfaces of the track and guide the crank arms along the track such that the overall length of the crank arm assembly can vary from the collapsed to extended positions as the crank arm assembly rotates through each revolution. The side of the sliding section 7300 that interfaces with the track also includes a parallel track roller 7390 to reduce frictional forces associated with the side section coming into contact with the tracks. The amount, size, and type of bearings are optimized to reduce the frictional forces associated with the mating interfaces. The opposite end of the sliding section 7300 may also include a fastener feature 7320 designed to interface with a mechanism designed to apply the cranking force, such as pedals 9500 in FIG. 9 on a bicycle.

FIG. 8 illustrates a crank arm assembly with a single rail section 8200. In this configuration the sliding section 8300 includes a hollow section 8330 which allows the sliding section 8300 to expand and collapse along the rail section 8200. To reduce friction, rolling bearing 8340 are mounted inside the hollow section 8330. The roller bearings 8340 are designed to run freely along the bearing surfaces of the rail section 8200 and guide the sliding section 8300 along the rail section 8200 such that the overall length of the crank arm assembly can vary from the collapsed to extended positions as the crank arm assembly rotates through each revolution. The sliding section 8300 also includes a cover 8310 to cover the hollow section 8330 and keep the rail section 8200 and roller bearings 8340 in tact. The side opposite the cover includes track rollers 8400 that interface with the track and serve to reduce frictional forces as previously described. This side may also include a parallel track roller 8390 to further reduce frictional forces associated with the side section coming into contact with the tracks. The opposite end of the sliding section 8300 may include a fastener feature 8320 designed to interface with a mechanism designed to apply the cranking force, such as pedals 9500 in FIG. 9 on a bicycle.

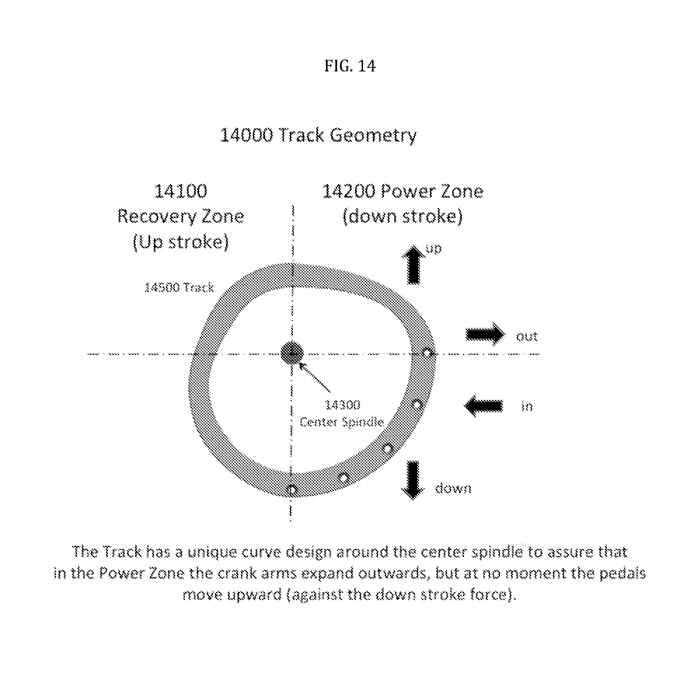

FIG. 9 illustrate the crank arm assembly 9000 that also includes at least two track rollers 9100 mounted to the side of each sliding section 9300. FIG. 9 illustrates how the track rollers 9100 interact with the track 9600. The track rollers 9100 are placed on the side of the sliding section 9300 that interfaces with the tracks 9600. The track rollers 9100 are designed to reduce friction and counter inertial forces associated with the crank arm assembly 9400 sliding along the tracks 9600. Depending on the angular position of the crank arm assembly 9400, when only one roller in a groove is used, the roller will reverse its spinning direction two times in each revolution, causing unnecessary friction and counter inertia. This invention uses two rollers turning in opposite directions relative to each other, but never reversing the spin direction, to eliminate counter inertia. FIG. 14 shows a preferred embodiment for the track geometry 14000.

The track 14500 has a unique curve designed around the center spindle 14300 to assure that in the power zone 14200 the crank arms expand outwards, and do not allow the sliding mechanism to retract—or move against the down stroke force.

FIG. 13 shows additional detail for the friction reducing mechanisms. Friction forces may be reduced by including a parallel track roller 13200 that bears the side load of the crank arm as the crank arm assembly rotates around the surface of the track, as shown in FIG. 13c). To further reduce friction, the rail section 13300 of each crank arm may be designed with two rods. The sliding section 13400 of the crank arm may include friction reducing mechanism 13500, such as low friction bushings, to interface with the bearing surface of each, as exemplified in FIG. 13b).

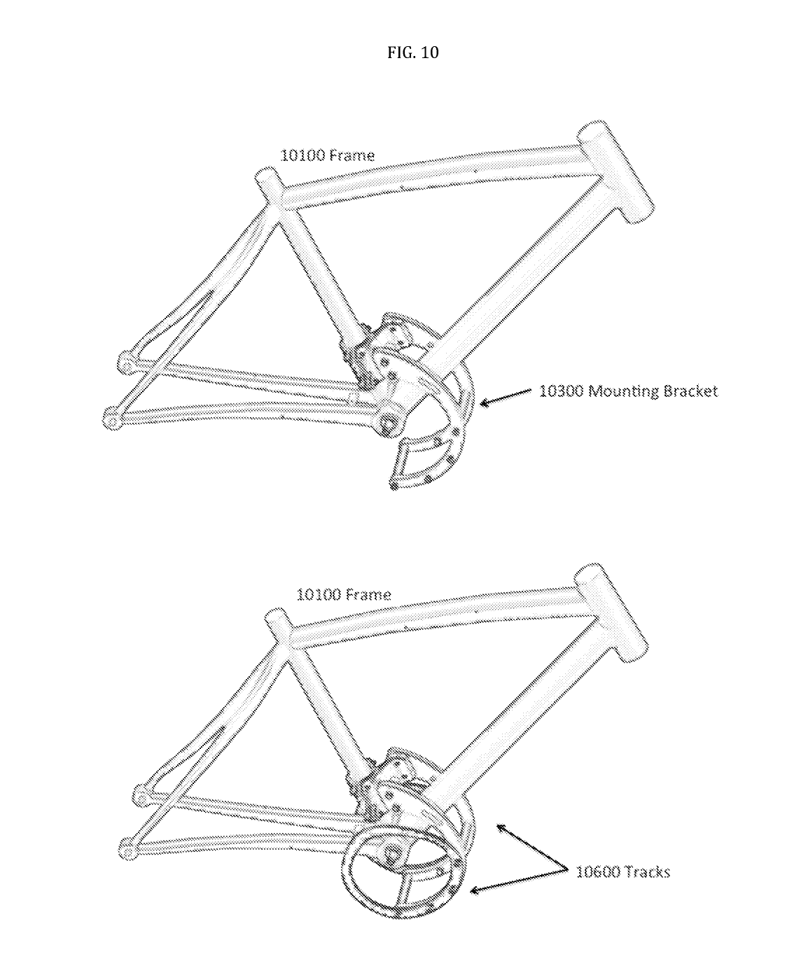

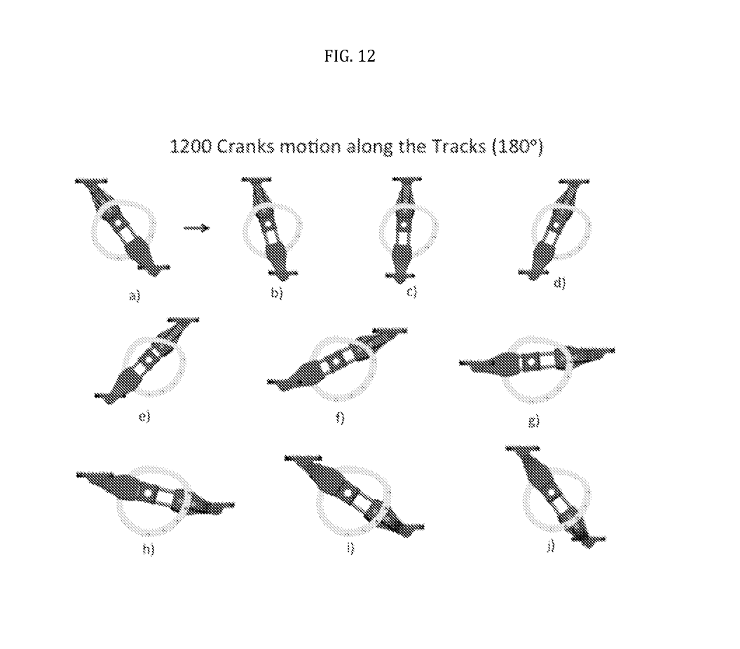

Next, FIG. 10 shows the assembly with two tracks 10600 mounted on each side of the frame 10100. The tracks 10600 are mounted to the frame 10100 with a mounting bracket 10300. The mounting bracket 10300 and tracks 10600 are designed in a way such that they can be removed from the frame 10100. The mounting bracket 10300 and tracks 10600 are designed such that they can be easily installed or removed from an existing frame 10100. The mounting bracket 10300 also includes fastening features that allow the tracks 10600 to be mounted to the mounting brackets 10300. There may be multiple fastening features that enable different size tracks 10600 to be attached to the mounting brackets 10300. The tracks 10600 are used to control the length of the crank arms at each angular position. The shape of each track 10600 is designed to coincide with the optimum crank arm length at the various angular positions as the crank arm rotates through a complete revolution, as shown if FIG. 12. For example, the tracks geometry may take on an oblong elliptical shape with the major diameter coinciding with the crank arms motion through the power zone.

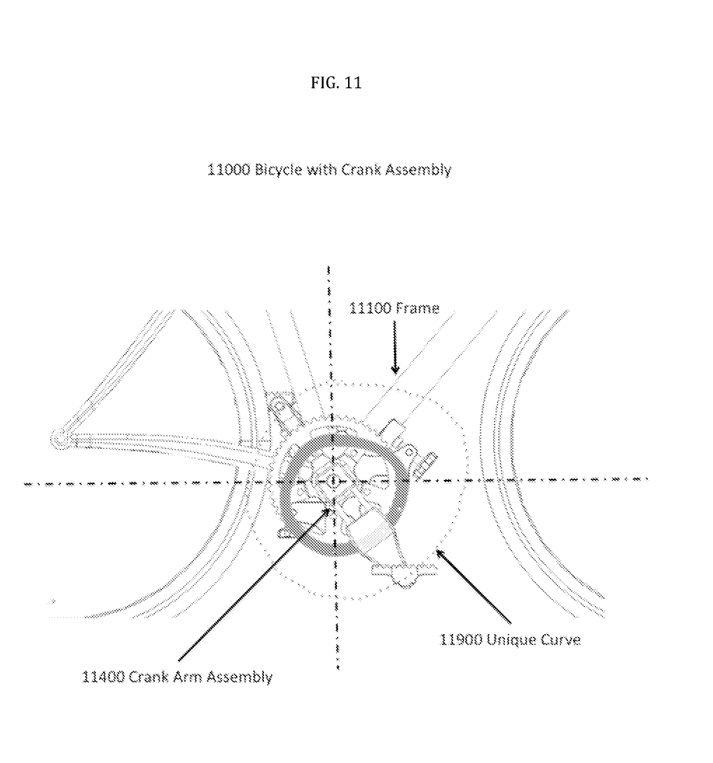

Finally, FIG. 11 shows the trajectory of the crank arm assembly 11400 and pedals in this invention follows a unique curve 11900. The unique curve 11900 is neither an eccentric circle nor an ellipse. The unique curve 11900 is an elongated irregular closed curve that slightly tilts downwards. The unique curve 11900 is designed to make sure that the two rollers slide freely on the track at every angular position. The unique curve 11900 also prevents the crank arm assembly 11400 to move upwards at any point during the stroke through the most efficient zone. The unique curve 11900 is designed around the spindle to assure that in the most efficient zone the crank arms expand outwards, but at no moment the sliding section and pedals move upward (against the down stroke force). The unique curve 11900 also allows the optimum expansion and contraction of the crank arms without sacrificing spinning momentum. Furthermore, the unique curve 11900 also makes sure that the pedals maintain good clearance from the ground when they swing through the bottom of each revolution.

The terms and expressions, which have been employed herein, are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A bicycle with a crank system designed to control the varying length of crank arms as the crank arm assembly rotates about a spindle comprising:
diametrically opposed crank arm assemblies attached to a spindle, wherein each crank arm assembly comprises a mounting section, blade rail section, sliding section, and pedals;
the mounting section attached to the spindle;
one end of the rail section attached to the mounting section;
the opposite end of the rail section attached to one end of the sliding section, wherein the sliding section includes a feature that allows the sliding section to collapse and expand along the rail section and at least one parallel roller mounted to the side of the sliding section that interfaces with the track;
pedals attached to the mounting feature at the opposite end of the sliding section; and a track, mounted to the bicycle frame, used to control the collapse and expansion of the sliding section along the rail section to vary the length of the crank arm assembly as the crank arm assembly rotates about the spindle, wherein the geometry of the track ensures that the sliding section collapses only during the up stroke.

15. The system of claim 14, wherein the crank system is mounted to an existing bicycle, without interfering with the existing wheels, sprockets, brakes, shifters, or any other components.

16. The system of claim 14, wherein the rail section and tracks are interchangeable and can be exchanged with a different length rail section and different size tracks to accommodate different terrains or different sized riders.

17. The system of claim 14, wherein the rail section comprises two parallel rods and the sliding section includes low friction bushings to interface with the rods.

18. The system of claim 17, wherein the cross sectional geometry of the rods is circular.

19. The system of claim 14, wherein the crank arm assembly is completely collapsed to the shortest length while the crank arm rotates through the least efficient zone.

20. The system of claim 14, wherein the crank arm extends to the fully extended position to maximize the torque applied as the crank arm rotates through the most efficient zone.

21. The system of claim 14, wherein the sliding section includes a friction reducing mechanism within the feature that allows the sliding section to collapse and expand along the rail section, thus reducing the sliding friction as the crank arm expands and collapses.

22. The system of claim 14, wherein the crank arm assembly includes at least two track rollers mounted to the side of each sliding section, the track rollers designed to guide the crank arm along the track.

23. The system of claim 22, wherein the two track rollers turn in opposite directions relative to each other never reversing the spin direction.

24. The system of claim 14, wherein the parallel roller is designed to reduce friction and counter lateral bearing forces associated with the crank arm sliding along the track.

25. The system of claim 14, wherein the rail section comprises a solid piece of material with at least two smooth bearing surfaces.

26. The system of claim 14, wherein the geometry of the rail section includes through holes, or gussets to optimize the strength to weight ratio needed for associated loads and stresses.

27. The system of claim 14, wherein the rail section and mounting section are fabricated from a single process such as being machined from a single block of material, or formed as a single piece from a mold.

28. The system of claim 14, wherein the geometry of the track is an oblong elliptical shape with the major diameter coinciding with the crank arms motion through the most efficient power zone.

29. A bicycle with a crank system comprising:
diametrically opposed crank arm assemblies attached to a spindle, wherein each crank arm assembly comprises a mounting section, rail section, sliding section, and pedals;
the mounting section attached to the spindle;
one end of the rail section attached to the mounting section, wherein the rail section comprises a solid piece of material with at least two smooth bearing surfaces;
the opposite end of the rail section attached to one end of the sliding section, wherein the sliding section includes a feature that allows the sliding section to collapse and expand along the rail section;
pedals attached to the mounting feature at the opposite end of the sliding section; and
a track, mounted to the bicycle frame, used to control the collapse and expansion of the sliding section along the rail section to vary the length of the crank arm assembly as the crank arm assembly rotates about the spindle, wherein the geometry of the track ensures that the sliding section collapses only during the up stroke.

30. The system of claim 29, wherein the crank system is mounted to an existing bicycle, without interfering with the existing wheels, sprockets, brakes, shifters, or any other components.

31. The system of claim 29, wherein the rail section comprises two parallel rods and the sliding section includes low friction bushings to interface with the rods.

32. The system of claim 29, wherein the sliding section includes a friction reducing mechanism within the feature that allows the sliding section to collapse and expand along the rail section, thus reducing the sliding friction as the crank arm expands and collapses.

33. The system of claim 29, wherein the crank arm assembly includes at least two track rollers mounted to the side of each sliding section, the track rollers designed to guide the crank arm along the track.
